(19) United States
(12) Patent Application Publication
(10) Pub. No.: US 2003/0009928 A1
(43) Pub. Date: Jan. 16, 2003

(54) Mousetrap

(76) Inventor: Barry Stoddard, Hinton, IA (US)

Correspondence Address: DAVIS, BROWN, KOEHN, SHORS & ROBERTS, P.C., THE FINANCIAL CENTER, 666 WALNUT STREET, SUITE 2500, DES MOINES, IA, 50309-3993, US

(21) Appl. No.: 09/904,216

(22) Filed: Jul. 12, 2001

(51) Int. Cl. A01M 23/36; A01M 23/30

(52) U.S. Cl. 43/77

(57) ABSTRACT

A mousetrap comprising a base with a first end and a second end located opposite to the first end. A spring is mounted to the base, and is capable of being biased for movement toward the first end of the base. A collar extends from the spring, such that when the mousetrap is loaded by moving the collar to the second end of the base. A pin having a fixed end and a free end is mounted to the base, wherein the fixed end of the base is mounted to the base proximate to the second end of the base. A cage is mounted to the base proximate to the first end of said base. The cage is capable of retaining the bait. A catch is mounted to the cage and is capable of retaining the free end of the pin when the mousetrap is loaded, and wherein the mousetrap is triggered by the release of the free end of the pin from the catch.

### BACKGROUND OF THE INVENTION

The present invention relates to a mousetrap. In particular, to a mousetrap that utilizes a cage to more securely retain bait.

Spring type baited mousetraps are well known in the prior art. These traps use a spring-loaded mechanism and baited plate to lure a mouse into the mousetrap. When the mouse approaches the mousetrap to attempt to remove or eat the bait, the activity of the mouse triggers the mousetrap that then captures the mouse in the mousetrap.

Despite the longstanding use of the spring traps, they suffer from one important drawback. Many mice can evade capture from the mousetrap by removing the bait with sufficient agility to avoid triggering the mousetrap. A common frustration of many users of the spring traps comprises returning to the mousetrap only to find the mousetrap fully loaded and the bait gone, or the mousetrap sprung and the bait missing. In either event, the mouse is nowhere to be found.

Thus a need exists for an improved spring type bated mousetrap that prevents the mice from removing the bait while still evading the mousetrap.

### SUMMARY OF THE INVENTION

An object of the present invention comprises providing a mousetrap that more securely retains bait.

These and other objects of the present invention will become apparent to those skilled in the art upon reference to the following specification, drawings, and claims.

The present invention intends to overcome the difficulties encountered heretofore. To that end, the mousetrap comprises a base with a first end and a second end located opposite to the first end. A spring is mounted to the base, and is capable of being biased for movement toward the first end of the base. A collar extends from the spring, such that when the mousetrap is loaded by moving the collar to the second end of the base. A pin having a fixed end and a free end is mounted to the base, wherein the fixed end of the base is mounted to the base proximate to the second end of the base. A cage is mounted to the base proximate to the first end of said base. The cage is capable of retaining the bait. A catch is mounted to the cage and is capable of retaining the free end of the pin when the mousetrap is loaded, and wherein the mousetrap is triggered by the release of the free end of the pin from the catch.

### BRIEF DESCRIPTION OF THE DRAWINGS

FIG. 1 is a perspective view of a prior art mousetrap.

FIG. 2 is a perspective view of a mousetrap of the present invention.

FIG. 3 is a top view of the mousetrap of FIG. 2, with an alternative catch.

FIG. 4 is a side view of the mousetrap of FIG. 2.

FIG. 5 is a perspective view of an alternative cage.

FIG. 6 is a side view of the mousetrap of FIG. 2 showing movement of the mousetrap.

### DETAILED DESCRIPTION OF THE INVENTION

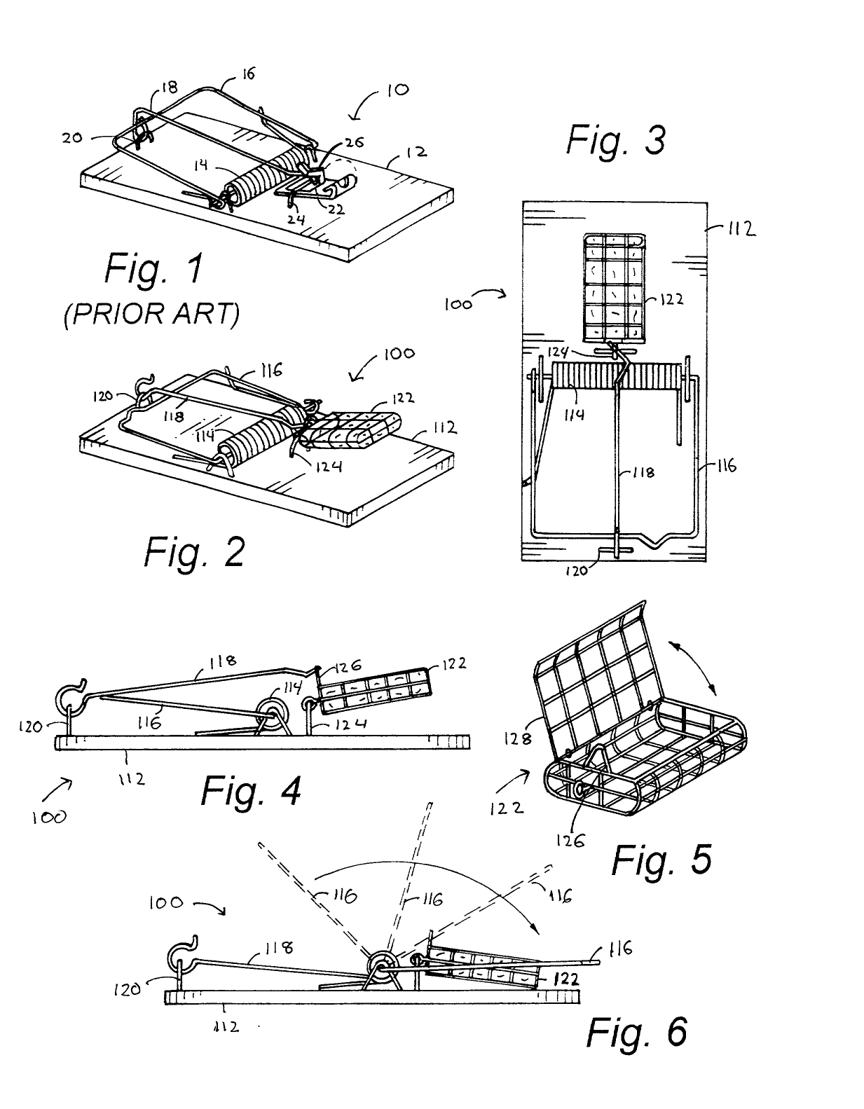

In the Figures, FIG. 1 shows a prior art mousetrap 10 of the spring and bait variety. The mousetrap 10 includes a base 12 generally constructed of a lightweight material like wood or plastic. A spring 14 is rigidly mounted to the base 12, a collar 16 extends from the spring 14. The mousetrap 10 also includes plate 22 that is fastened to the base 12 with fastener 24. The plate 22 includes a catch 26 designed to receive a free end of an extended pin 18. The end of the pin 18 opposite the free end is affixed to the base 12 with fastener 20.

The spring 14 is biased such that the spring 14 urges the collar 16 toward the portion of the mousetrap 10 containing the plate 22. FIG. 1 shows the mousetrap 10 in the loaded position, wherein release of the spring 14 will drive the collar 16 to the opposite end of the mousetrap 10. To load the mousetrap 10 the collar 16 is moved to the position shown in FIG. 1, and the pin 18 is placed over the collar 16 with the free end of the pin 18 releaseably retained by catch 26. Bait is placed on the upper surface of the plate 22. The plate 22 is tilted slightly upward such that movement or pressure on the plate 22 in the downward direction will release the free end of the pin 18 from the catch 26, allowing the spring to release thereby pinning the mouse between the base 12 and the collar 16. As mentioned hereinabove, the prior art mousetrap 10 suffers from the drawback that mice can remove the bait from the plate 22 without triggering the mousetrap 10.

FIGS. 2-6 show a mousetrap 100 of the present invention, similar in construction to the prior art mousetrap 10. The mousetrap 100 includes a base 112 generally constructed of a lightweight material like wood or plastic. A spring 114 is rigidly mounted to the base 112, a collar 116 extends from the spring 114. The mousetrap 110 also includes cage 122 that is fastened to the base 112 with fastener 124. The cage 122 includes a catch 126 designed to receive a free end of an extended pin 118. The end of the pin 118 opposite the free end is affixed to the base 112 with fastener 120.

In the embodiment of the invention shown in the Figures, the cage 122 comprises a thing gauge wire mess material. The mess is such that openings between the strands of the mess will allow for inserting the bait, but will make it difficult for the mouse to remove the bait. This will require the mouse to apply more force and agitation to the cage 122, then the mouse would apply to the prior art mousetrap 10. This will ensure triggering of the mousetrap 100, with the mouse still in the proximity of the baited cage 122. The difficultly in removing the bait from the cage 122 will substantially increase the effectiveness of the mousetrap 100 in catching its intended target. Those of ordinary skill in the art will understand that the cage 122 can vary from the embodiment shown in the Figures without departing from the scope of the intended invention. For example, the gauge of the mesh may vary, the density of the strands may vary, the size and shape may vary, and the material used for construction may vary. The cage 122 could be constructed of plastic and include perforations instead of a mesh.

In addition, FIG. 5 shows an embodiment of the cage 122 that includes a hinged door 128 in the cage 122 that will allow for easier baiting of the cage 122. Opening the door 128 will allow for easy insertion of the bait. Then with the door 128 closed the mice will not be able to easily remove the bait.

The spring 114 is biased such that the spring 114 urges the collar 116 toward the portion of the mousetrap 110 containing the cage 122. FIG. 2 shows the mousetrap 100 in the loaded position, wherein release of the spring 122 will drive the collar 116 to the opposite end of the mousetrap 100 (see FIG. 6). To load the mousetrap 100, the collar 116 is moved to the position shown in FIG. 2, and the pin 118 is place over the collar 116 with the free end of the pin 118 releaseably retained by catch 126. Bait is placed in the cage 122. The cage 122 is tilted slightly upward such that any movement or pressure on the cage 122 in the downward direction will release the free end of the pin 118 from the catch 126, allowing the spring to release thereby pinning the mouse between the base 112 and the collar 116.

FIG. 3 shows an embodiment of the present invention where the catch 126 of the cage 122 is substantially coplanar with the top of the cage 122. By constructing the catch 126 narrowly and placing the catch 126 in the same plane as the cage 122, side-to-side movement, as well as downward movement of the cage 122 will trigger the mousetrap 100. This will also increase the efficiency of the mousetrap 100 by making it easier to trigger the mousetrap 100. An additional embodiment of cage 122 would include wires extending partially into, or completely across, the interior of the cage 122. This would provide further securement of the bait inside the cage 122, thereby requiring more agitation of the cage 122 by the mouse. This would increase the likelihood of the mouse triggering the mousetrap 100.

Any suitable conventional bait can be used with the mousetrap 100. For example, bread, cereal, grains, peanut butter, and the like. Baiting the mousetrap 100 can be accomplished by placing the bait inside the cage 122 using the door 128, rubbing the bate on the outside of the cage 122 until a sufficient quantity of the bait is captured inside the cage 100, or simply inserting the bait between the mess or opening of the cage 122.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A mousetrap, said mousetrap comprising:
a) a base with a first end and a second end opposite thereto;
b) a spring mounted to said base, capable of being biased for movement toward said first end of said base;
c) a collar extending from said spring, wherein said mousetrap is loaded when said collar is moved to said second end of said base;
d) a pin having a fixed end mounted to said base proximate to said second end of said base, and having a free end opposite thereto;
e) a cage mounted to said base, said cage located proximate to said first end of said base, said cage capable of retaining bait; and
f) a catch mounted to said cage capable of retaining said free end of said pin when said mousetrap is loaded, and wherein said mousetrap is triggered by the release of said free end of said pin from said catch.

2. The invention in accordance with claim 1 wherein said cage is a wire mesh cage.

3. The invention in accordance with claim 1 wherein said cage further comprises a door for opening to insert bait into said cage.

4. The invention in accordance with claim 1 wherein said catch is substantially coplanar with the top of said cage.
